(19) United States
(12) Patent Application Publication
(10) Pub. No.: US 2024/0308304 A1
(43) Pub. Date: Sep. 19, 2024

(54) SUN VISOR FOR CARS

(71) Applicant: Dongguan Honggancheng Electronic Materials Co., Ltd., Dongguan (CN)

(72) Inventor: Fenggang ZHU, Dongguan (CN)

(73) Assignee: Dongguan Honggancheng Electronic Materials Co., Ltd., Dongguan (CN)

(21) Appl. No.: 18/185,452

(22) Filed: Mar. 17, 2023

(51) Int. Cl. B60J 3/02

(52) U.S. Cl. CPC B60J 3/023; B60J 3/0278

(57) ABSTRACT

The invention relates to the technical field of sun visors, and discloses a sun visor for cars including a back plane and a sun visor lens. An inner portion of the back plane is fixedly connected with iron sheets, a left portion of an upper end of the back plane is fixedly connected with a left buckle, and a right portion of the upper end of the back plane is fixedly connected with a right buckle. For the sun visor for cars according to the invention, the sun visor for cars is easy to install, and the position of the sun visor can also be adjusted flexibly to meet the sunshade needs at different times and is suitable for wide use.

### FIELD OF THE INVENTION

The invention relates to the technical field of sun visors, in particular, to a sun visor for cars.

### BACKGROUND OF THE INVENTION

The sun visor for cars is designed to avoid the glare of the sun, which is a board installed above the driver to prevent the glare of the sun. The irradiance of the sun to the eyes can be adjusted through the sun visor, which avoids the occurrence of traffic accidents and thus protects the personal safety of the driver. The sun visor is made of plastic, EPP, PU foam, cardboard, etc., and can be divided into three types of a front shield, a side shield and a rear shield. The range of sunshade of existing sun visor for cars is narrower. As the sunlight changes over time, the angle and range of the light entering the car also changes. However, the existing sun visors for cars cannot be adjusted according to the light of the sun, so that they cannot meet the actual sun shading needs and reduce the practicability. Therefore, we put forward a sun visor for cars.

### BRIEF SUMMARY OF THE DISCLOSURE

A main objective of the invention is to provide a sun visor for cars, which may effectively solve the problems in the background.

In order to achieve the foregoing objective, technical solutions of the invention are:

A sun visor for cars includes a back plane and a sun visor lens, wherein an inner portion of the back plane is fixedly connected with iron sheets, a left portion of an upper end of the back plane is fixedly connected with a left buckle, and a right portion of the upper end of the back plane is fixedly connected with a right buckle; a rear portion of an upper end of the sun visor lens is fixedly connected with a sun visor bottom plate a middle portion of an upper end of the sun visor bottom plate is inserted and fixedly connected with a plurality of first magnets and a plurality of second magnets, and two second magnets are distributed between the two adjacent first magnets.

Preferably, a middle portion of a front end of the sun visor lens is provided with a hand-held projecting sheet, a middle portion of an upper end of the hand-held projecting sheet is provided with a through hole, and a sewing thread is commonly sewn between peripheries of the upper end of the back plane.

Preferably, the back plane is made by sewing two fixing plates with the sewing thread, and the iron sheet is pasted and fixed between middle portions of opposite surfaces of the two fixing plates by glue.

Preferably, an integrated structure is arranged between the hand-held projecting sheet and the sun visor lens, both upper end surfaces of the plurality of first magnets and upper end surfaces of the plurality of second magnets are flush with an upper end surface of the sun visor bottom plate, and the sun visor bottom plate is pasted on the sun visor lens by glue.

Preferably, the left buckle includes a fixing belt, one end of the fixing belt is sleeved with a fixing buckle lock, and one end of the fixing belt away from the fixing buckle lock is sleeved with a fixing release buckle; a front portion of an outer surface of the fixing belt is sleeved with a Tri glide button, and both a front portion of a lower end and a rear portion of the lower end of the fixing belt are sewn to a front side of the left portion of the upper end and a rear side of the left portion of the upper end of the back plane by the sewing thread.

Preferably, the fixing buckle lock is engaged with the fixing release buckle, and a structure of the left buckle is consistent with a structure of the right buckle.

Preferably, the sun visor lens and the back plane are connected with each other by magnetic attraction, and may also be connected with each other by means of rollers, glue and velcro.

Compared with the prior art, the present invention has the following beneficial effects:

In the sun visor for cars according to the invention, by inserting the fixing release buckle into the fixing buckle lock, the back plane may be buckled onto the car through the left buckle and the right buckle, so that the back plane may always be fixed on the roof of the car, and the back panel may be quickly installed and fixed; then, the sun visor lens may be absorbed and fixed on the back plane by the magnetic attraction generated between the first magnet and the second magnet and the iron sheets, so that the sunshade function may be realized through the sun visor lens, wherein the back panel and the sun visor lens are two separate parts, and the sun visor lens may be moved by magnetic attraction or the position of the sun visor lens on the back panel may be flexibly adjusted according to the change of sunlight; therefore, the sunshade demand can be met according to actual conditions, the range of the sunshade is expanded, and the practicability of the sun visor is effectively improved.

### BRIEF DESCRIPTION OF THE DRAWINGS

FIG. 1 is an exploded view of an overall structure of a sun visor for cars according to the invention;

FIG. 2 is an exploded view of an overall structure of a sun visor for cars according to the invention;

FIG. 3 is a view showing the connection between a back plane of the sun visor for cars and a left buckle and a right buckle according to the invention;

FIG. 4 is a view of an overall structure of the left buckle of the sun visor for cars according to the invention.

In figures: 1, back plane; 2, iron sheet; 3, left buckle; 4, right buckle; 5, sun visor lens; 6, sun visor bottom plate; 7, first magnet; 8, second magnet; 9, hand-held projecting sheet; 10, through hole; 11, sewing thread; 31, fixing belt; 32, fixing buckle lock; 33, fixing release buckle; 34, Tri glide button.

### DETAILED DESCRIPTION OF THE INVENTION

In order to make the technical means, creative features, achievement goals and effects achieved by the invention easy to understand, the invention will be further described below in conjunction with specific embodiments.

In the description of the present invention, it should be noted that orientations or position relationships indicated by terms “upper”, “lower”, “inner”, “outer”, “front end”, “rear end”, “both ends”, “one end”, “the other end” and the like are orientations or position relationships shown in the drawings, and these terms are merely for facilitating description of the present invention and simplifying the description, but not for indicating or implying that the mentioned device or elements must have a specific orientation and must be established and operated in a specific orientation, and thus, these terms cannot be understood as a limitation to the present invention. Moreover, terms like “first” and “second” are only used for description, not be considered as a designation or designation of relative importance.

In the description of the present invention, it should be noted that, unless otherwise clearly specified and limited, meanings of terms “install”, “provided with”, and “connected to” should be understood in a board sense. For example, the “connection” may be a fixed connection, a removable connection, or an integral connection; may be a mechanical connection or an electrical connection; may be a direct connection or an indirect connection by using an intermediate medium; or may be intercommunication between two components. For those of ordinary skill in the art, specific meanings of the above terms in the present invention may be understood based on specific situations.

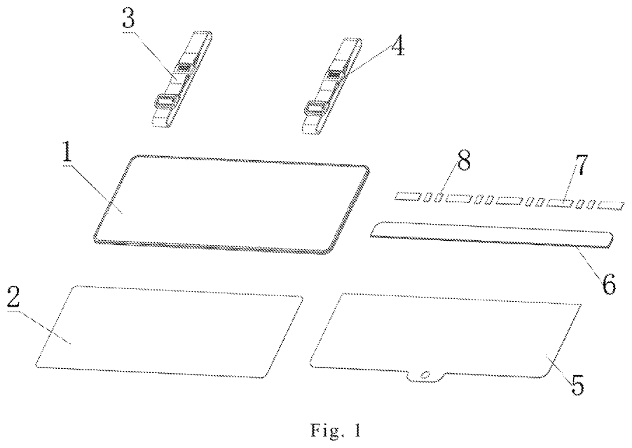

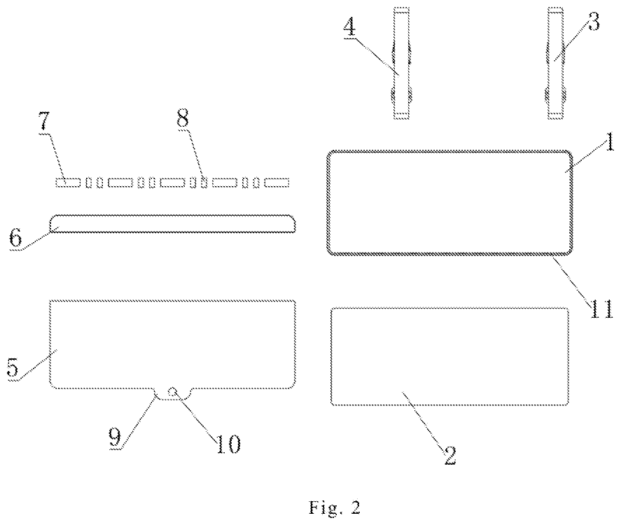

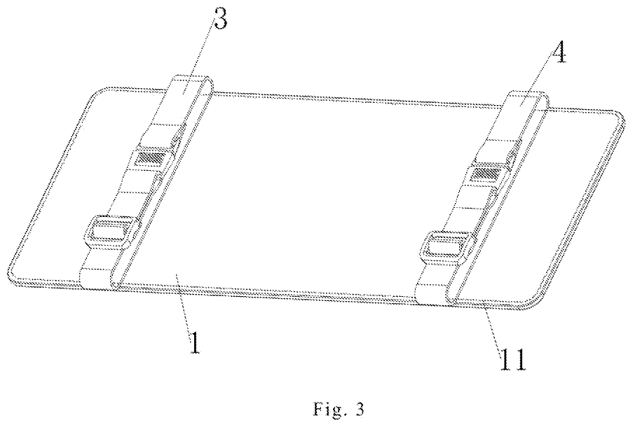

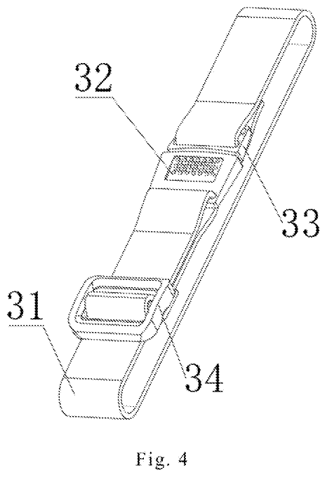

With reference to FIGS. 1 to 4, the invention provides a technical solution:

A sun visor for cars includes a back plane 1 and a sun visor lens 5, wherein an inner portion of the back plane 1 is fixedly connected with iron sheets 2, a left portion of an upper end of the back plane 1 is fixedly connected with a left buckle 3, and a right portion of the upper end of the back plane 1 is fixedly connected with a right buckle 4; a rear portion of an upper end of the sun visor lens 5 is fixedly connected with a sun visor bottom plate 6, a middle portion of an upper end of the sun visor bottom plate 6 is inserted and fixedly connected with a plurality of first magnets 7 and a plurality of second magnets 8, and two second magnets 8 are distributed between the two adjacent first magnets 7.

In the embodiment, a middle portion of a front end of the sun visor lens 5 is provided with a hand-held projecting sheet 9, a middle portion of an upper end of the hand-held projecting sheet 9 is provided with a through hole 10, and a sewing thread 11 is commonly sewn between peripheries of the upper end of the back plane 1; the back plane 1 is made by sewing two fixing plates with the sewing thread 11, and the iron sheet 2 is pasted and fixed between middle portions of opposite surfaces of the two fixing plates by glue; an integrated structure is arranged between the hand-held projecting sheet 9 and the sun visor lens 5 so that the hand-held projecting sheet 9 and the sun visor lens 5 become an integral body, and both upper end surfaces of the plurality of first magnets 7 and upper end surfaces of the plurality of second magnets 8 are flush with an upper end surface of the sun visor bottom plate 6 so that the sun visor bottom plate 6 is absorbed and fixed on the back plane 1 by the plurality of first magnets 7 and the plurality of second magnets 8, which facilitate the absorption and fixing of the sun visor lens 5; the sun visor bottom plate 6 is pasted on the sun visor lens 5 by glue so that the sun visor bottom plate 6 is firmly fixed with the sun visor lens 5; the plurality of first magnets 7 are configured as horizontal large magnets, and the plurality of second magnets 8 are configured as vertical small magnets, so that the adsorption force to the back plane 1 may be improved through the staggered distribution of the plurality of horizontal large magnets and the plurality of vertical small magnets, thereby making the suction and fixation between the sun visor bottom plate 6 and the back plane 1 more firm and stable.

In the embodiment, the left buckle 3 includes a fixing belt 31, one end of the fixing belt 31 is sleeved with a fixing buckle lock 32, and one end of the fixing belt 31 away from the fixing buckle lock 32 is sleeved with a fixing release buckle 33; a front portion of an outer surface of the fixing belt 31 is sleeved with a Tri glide button 34, and both a front portion of a lower end and a rear portion of the lower end of the fixing belt 31 are sewn to a front side of the left portion of the upper end and a rear side of the left portion of the upper end of the back plane 1 by the sewing thread 11; the fixing buckle lock 32 is engaged with the fixing release buckle 33 so that the assembly and disassembly of the back plane 1 are very convenient, and a structure of the left buckle 3 is consistent with a structure of the right buckle 4 so that the left and right parts of the back plane 1 may be respectively fixed on the car to complete the stable fixation of the back plane 1; the sun visor lens 5 and the back plane 1 are connected with each other by magnetic attraction, and may also be connected with each other by means of rollers, glue and velcro.

It should be noted that the invention is a sun visor for cars. During the use process of the invention, first the back plane 1 is placed on the roof of the car, and then the fixing release buckle 33 is inserted through the fixing members of the roof and into the fixing buckle lock 32 to be fixed so that the back plane 1 may be buckled onto the car through the left buckle 3 and the right buckle 4, and the back plane 1 may be always fixed on the roof above the driver; the back plane 1 may be installed and fixed quickly, and then the sun visor bottom plate 6 may be absorbed onto the back plane 1 through the magnetic attraction generated between the plurality of first magnets 7 and the plurality of second magnets 8 and the iron sheets 2 in the back plane 1, so that the sun visor lens 5 is located in front of the driver's line of sight, and the sunlight ahead may be blocked by the sun visor lens 5, thereby realizing the sunshade function of the sun visor for cars; further, when the sunlight irradiating into the car changes, the sun visor lens 5 may be moved by holding the hand-held projection sheet 9 to change the position where the sun visor bottom plate 6 is adsorbed on the back plane 1, so that the range of sunshade of the sun visor lens 5 may be adjusted, the sunshade position of the sun visor lens 5 may be flexibly adjusted, and also the actual sunshade needs may be met according to usage, thereby enlarging the range of sunshade of the sun visor lens 5 for effectively improving the practicality of the sun visor for cars; the back plane 1 and the sun visor lens 5 are all separated from each other in the sun visor, so that the sun visor lens 5 and the back plane 1 are connected with each other by magnetic attraction and may also be connected with each other by means of rollers, glue and velcro, which both may facilitate the flexible movement for the position of the sun visor lens 5.

The above shows and describes basic principles, main features and advantages of the invention. Those skill in the art shall understand that the invention is not limited by the above embodiment, what is described in the above embodiment and the specification is only the principle of the invention, on the premise of not deviating from the spirits and the scope of the invention, the invention may have various changes and improvements, and these changes and improvements shall fall within the scope requiring protection of the invention. The scope requiring protection of the invention is defined by the appended claims and equivalents thereof.

What is claimed is:

1. A sun visor for cars, comprising a back plane (1) and a sun visor lens (5), wherein an inner portion of the back plane (1) is fixedly connected with iron sheets (2), a left portion of an upper end of the back plane (1) is fixedly connected with a left buckle (3), and a right portion of the upper end of the back plane (1) is fixedly connected with a right buckle (4); a rear portion of an upper end of the sun visor lens (5) is fixedly connected with a sun visor bottom plate (6), a middle portion of an upper end of the sun visor bottom plate (6) is inserted and fixedly connected with a plurality of first magnets (7) and a plurality of second magnets (8), and two second magnets (8) are distributed between the two adjacent first magnets (7);
a middle portion of a front end of the sun visor lens (S) is provided with a hand-held projecting sheet (9), a middle portion of an upper end of the hand-held projecting sheet (9) is provided with a through hole (10), and a sewing thread (11) is commonly sewn between peripheries of the upper end of the back plane (1).

2. The sun visor for cars according to claim 1, wherein the back plane (1) is made by sewing two fixing plates with the sewing thread (11), and the iron sheet (2) is pasted and fixed between middle portions of opposite surfaces of the two fixing plates by glue.

3. The sun visor for cars according to claim 2, wherein an integrated structure is arranged between the hand-held projecting sheet (9) and the sun visor lens (5), both upper end surfaces of the plurality of first magnets (7) and upper end surfaces of the plurality of second magnets (8) are flush with an upper end surface of the sun visor bottom plate (6), and the sun visor bottom plate (6) is pasted on the sun visor lens (5) by glue.

4. The sun visor for cars according to claim 1, wherein the left buckle (3) comprises a fixing belt (31), one end of the fixing belt (31) is sleeved with a fixing buckle lock (32), and one end of the fixing belt (31) away from the fixing buckle lock (32) is sleeved with a fixing release buckle (33); a front portion of an outer surface of the fixing belt (31) is sleeved with a Tri glide button (34), and both a front portion of a lower end and a rear portion of the lower end of the fixing belt (31) are sewn to a front side of the left portion of the upper end and a rear side of the left portion of the upper end of the back plane (1) by the sewing thread (11).

5. The sun visor for cars according to claim 4, wherein the fixing buckle lock (32) is engaged with the fixing release buckle (33), and a structure of the left buckle (3) is consistent with a structure of the right buckle (4);
the sun visor for cars according to claim 1, wherein the sun visor lens (5) and the back plane (1) are connected with each other by magnetic attraction, and may also be connected with each other by means of rollers, glue and velcro.
